(19) United States
(12) Patent Application Publication
(10) Pub. No.: US 2002/0154159 A1
(43) Pub. Date: Oct. 24, 2002

(54) Method, apparatus, and program for associating successive repointing of a browser's load function with navigational links in web pages

(75) Inventors: Don Rutledge Day, Austin, TX (US); Rabindranath Dutta, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/838,378

(22) Filed: Apr. 19, 2001

(51) Int. Cl. G06F 3/00; G06F 13/00

(52) U.S. Cl. 345/738

(57) ABSTRACT

A mechanism is provided for associating a locational affinity between a series link and a cursor or other control to allow consistent paging through a series of pages without having to physically scroll the page and relocate the cursor over the link. A web browser scans for key phrases or words in links, as well as other indications of sequentiality, such as incrementing numbers and alphabetical patterns. The browser may scan the link text, uniform resource locators, graphic filenames, and alt text associated with graphics. When a series link is identified, such as a link to a “next” or “previous” page, the browser may automatically scroll the page and reposition the mouse cursor over the link. The browser may also provide a right-click menu that provides menu items associated with next page and previous page links. Furthermore, the browser may provide buttons in a toolbar for navigation between next page and previous page links. Preferences may be defined by the user for customizing the key words and interface options in order to identify series links.

### BACKGROUND OF THE INVENTION

1. Technical Field

The present invention relates to an improved data processing system and, in particular, to a method and apparatus for managing world wide web documents in a data processing system. Still more particularly, the present invention provides a method, apparatus, and program for associating a control with series links in a web browser.

2. Description of Related Art

The worldwide network of computers commonly known as the “Internet” has seen explosive growth in the last several years. Mainly, this growth has been fueled by the introduction and widespread use of so-called “web browsers,” which enable simple graphical user interface-based access to network servers, which support documents formatted as so-called “web pages.” These web pages are versatile and customized by authors. For example, web pages may mix text and graphic images. A web page also may include fonts of varying sizes.

A browser is a program that is executed on a graphical user interface (GUI). The browser allows a user to seamlessly load documents from the Internet and display them by means of the GUI. These documents are commonly formatted using markup language protocols, such as hypertext markup language (HTML). Portions of text and images within a document are delimited by indicators, which affect the format for display. In HTML documents, the indicators are referred to as tags. Tags may include links, also referred to as “hyperlinks,” to other pages. The browser gives some means of viewing the contents of web pages (or nodes) and of navigating from one web page to another in response to selection of the links.

The versatility and customization of web pages, however, are sometimes an impediment to users. Web documents may be designed to span multiple pages. Thus, navigating these documents requires the user to select links for the next page or previous page. The location of these links is dependent on the layout of the page, rather than the interface of the browser. Often, the cursor is not reliably positioned opportunely over the same link in successive pages. Having to repeatedly scroll a web page and reposition the cursor results in wasted time and repetitive stress syndrome activity. Furthermore, users that have difficulty with fine motor movements may experience frustration with successive pages in which the link to the next pages requires unnecessary scrolling and repositioning of the cursor.

Web browsers include toolbar buttons, keyboard shortcuts, and right-click menu items for navigation between a current document and a next or previous document in the document history. However, this often does not correspond to the succession of pages in a multiple page document. For example, a user may bookmark a page in the middle of the succession. When a user selects that bookmark, the document history does not accurately reflect the succession of pages.

Thus, it would be advantageous to provide a mechanism for associating successive repainting of a browser's load function with navigational links in web pages.

### SUMMARY OF THE INVENTION

The present invention provides a mechanism for associating a locational affinity between a series link and a cursor or other control to allow consistent paging through a series of pages without having to scroll the page and physically relocate the cursor over the link. A web browser scans for key phrases or words in links, such as “next,” “previous,” “more,” and “back.” The browser may scan the link text, uniform resource locators, graphic filenames, and alt text associated with graphics. When a series link is identified, such as a link to a “next” or “previous” page, the browser may automatically scroll the page and reposition the mouse cursor over the link. The browser may also provide other series link controls, such as a right-click menu that provides menu items associated with next page and previous page links. Furthermore, the browser may provide buttons in a toolbar for navigation between next page and previous page links. Preferences may be defined by the user for customizing the key words and interface options in order to identify series links.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIGS. 4A and 4B are examples of screens of display of a browser window in accordance with a preferred embodiment of the present invention;

FIG. 5 is an example screen of display of a browser window with a menu interface and toolbar interface for selection of next and previous page links in accordance with a preferred embodiment of the present invention;

FIG. 6 is an example of a screen of display of a preferences customization window in accordance with a preferred embodiment of the present invention;

FIG. 7 is a block diagram of a browser program in accordance with a preferred embodiment of the present invention; and

FIG. 8 is a flowchart illustrating the operation of a web browser in accordance with a preferred embodiment of the present invention.

### DETAILED DESCRIPTION OF THE PREFERRED EMBODIMENT

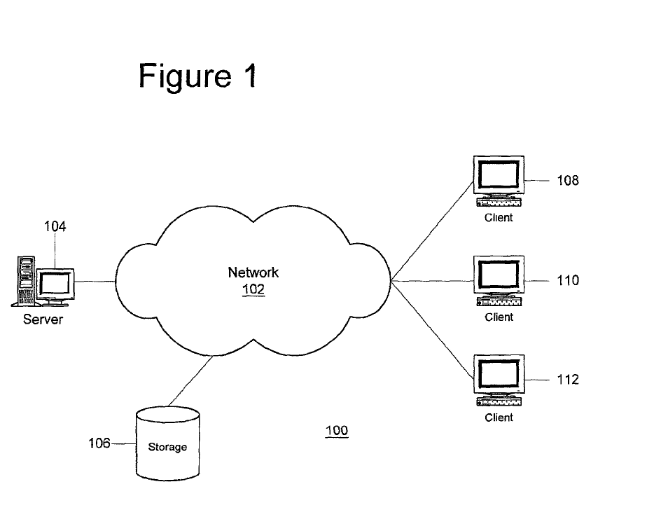

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

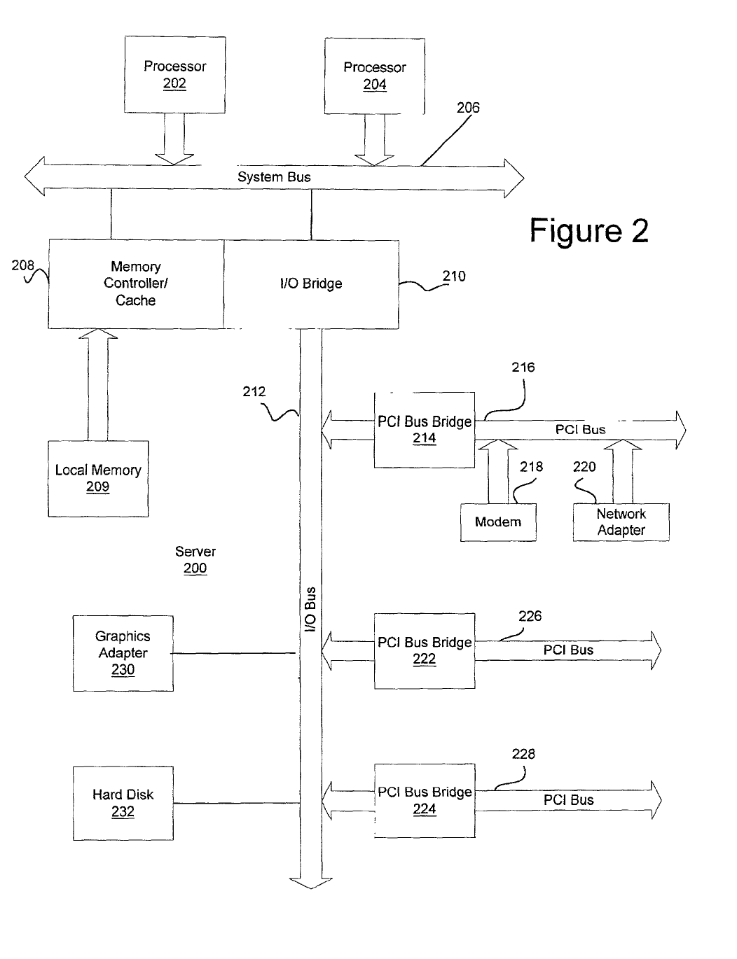

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

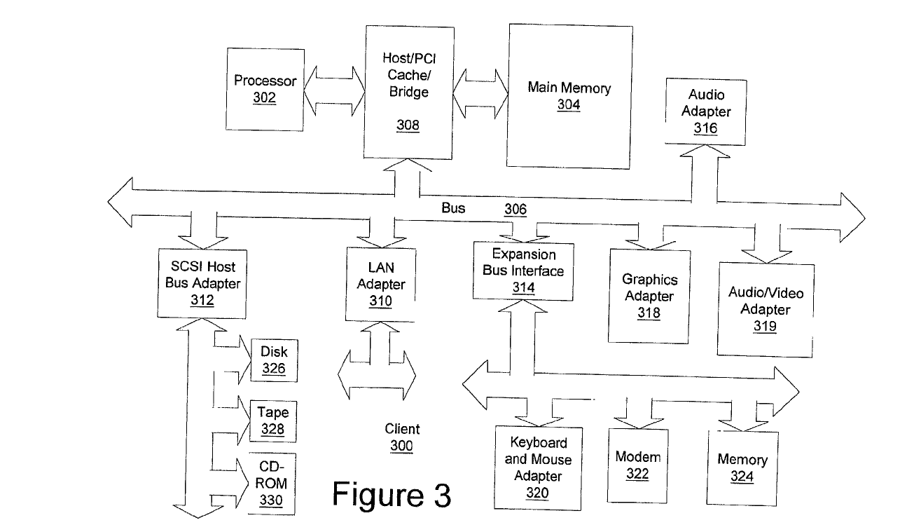

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

In particular, data processing system 300 may execute a web browser application program. A web browser is a program that is executed on a graphical user interface (GUI). The browser allows a user to seamlessly load documents from the Internet and display them by means of the GUI. These documents are commonly formatted using markup language protocols, such as hypertext markup language (HTML). Portions of text and images within a document are delimited by indicators, which affect the format for display. In HTML documents, the indicators are referred to as tags. Tags may include links, also referred to as “hyperlinks,” to other pages. The browser gives some means of viewing the contents of web pages (or nodes) and of navigating from one web page to another in response to selection of the links.

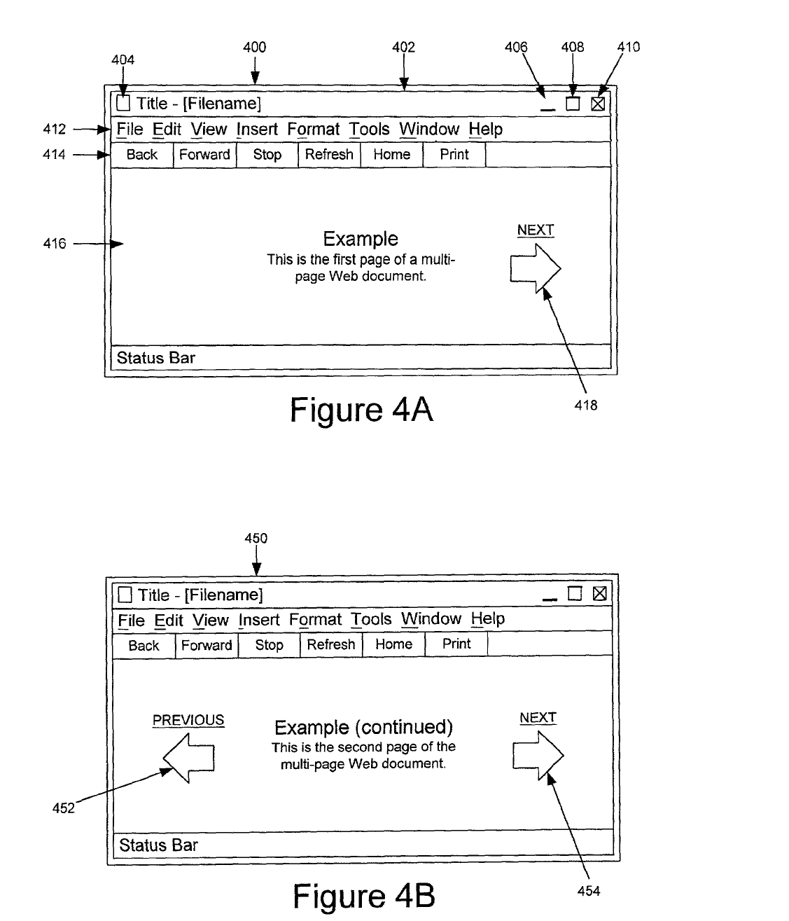

In accordance with a preferred embodiment of the present invention a mechanism associates a locational affinity between a series link and a cursor to allow consistent paging through a series of pages without having to physically relocate the cursor over the link. Examples of screens of display of a browser window are shown in FIGS. 4A and 4B in accordance with a preferred embodiment of the present invention. Particularly with reference to FIG. 4A, the screen comprises window 400, including a title bar 402, which may display the name of the application program. Title bar 402 also includes a control box 404, which produces a drop-down menu (not shown) when selected with the mouse, and “minimize” 406, “maximize” or “restore” 408, and “close” 410 buttons. The “minimize” and “maximize” or “restore” buttons 406 and 408 determine the manner in which the program window is displayed. In this example, the “close” button 410 produces an “exit” command when selected. The drop-down menu produced by selecting control box 404 includes commands corresponding to “minimize,” “maximize” or “restore,” and “close” buttons, as well as “move” and “resize” commands.

Browser window 400 also includes a menu bar 412. Menus to be selected from menu bar 412 may include “File,” “Edit,” “View,” “Insert,” “Format,” “Tools,” “Window,” and “Help.” However, menu bar 412 may include fewer or more menus, as understood by a person of ordinary skill in the art. The browser window also includes toolbar 414 with buttons used to navigate web pages. The buttons may include, but are not limited to, “Back,” “Forward,” “Stop,” “Refresh,” “Home,” and “Print.”

The browser window includes a display area 416 in which the contents of a document are displayed. The document may be retrieved from a server, such as server 104 in FIG. 1. The document may also be retrieved from another location, such as a hard disk in the client computer. As seen in FIG. 4A, a web page may include link 418 to the next page in a series of pages.

Turning now to FIG. 4B, browser window 450 includes a display area in which the contents of a document are displayed. As seen in FIG. 4B, a web page may include link 452 to the previous page in a series of pages and link 454 to the next page in the series of pages.

In accordance with a preferred embodiment of the present invention, the web browser scans for key phrases or words in links, such as “next,” “previous,” “more,” and “back.” The browser may scan the link text, uniform resource locators, graphic filenames, and alt text associated with graphics. When a “next” or “previous” page link is identified, the browser may automatically reposition the mouse cursor over the link. The browser may also automatically assign keyboard shortcuts to next and previous links.

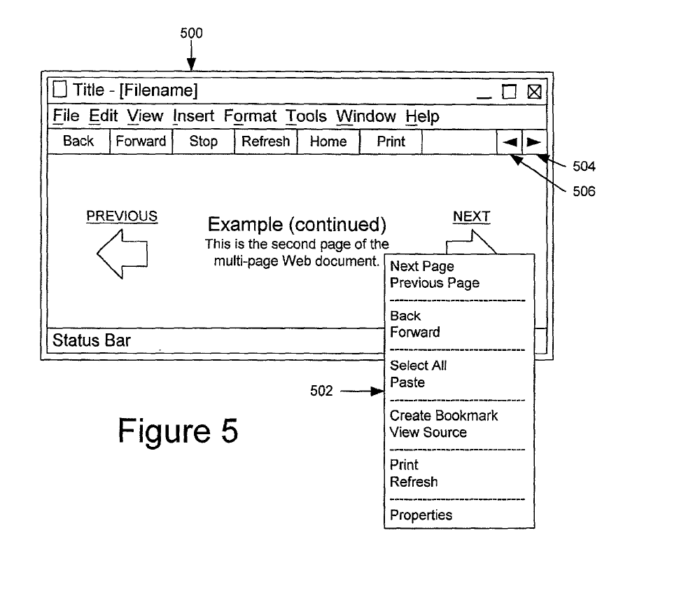

With reference to FIG. 5, an example screen of display of a browser window with a menu interface and toolbar interface for selection of next and previous page links is shown in accordance with a preferred embodiment of the present invention. Browser window 500 includes a display area in which the contents of a document are displayed. The web page may include a link to the previous page in a series of pages and a link to the next page in the series of pages. The browser provides right-click menu 502 that provides menu items associated with next page and previous page links. Furthermore, the browser window provides next page button 504 and previous page button 506 in the toolbar for navigation between the next page and previous page links.

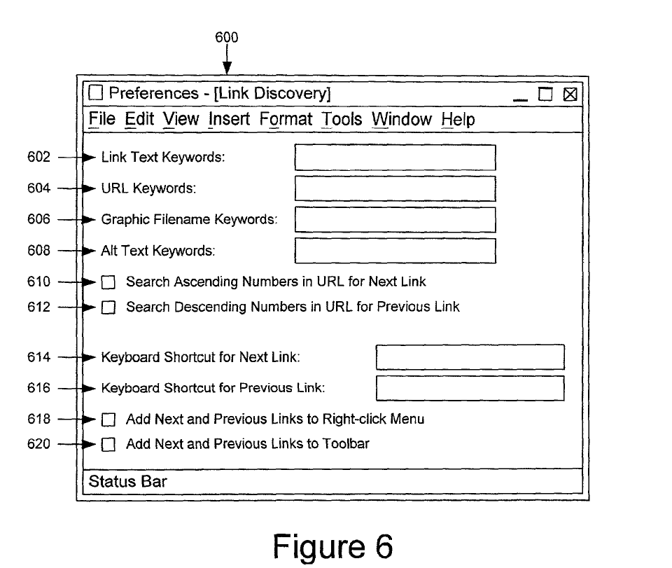

Preferences may be defined by the user for customizing the key words and interface options. An example of a screen of display of a preferences customization window is shown in FIG. 6 in accordance with a preferred embodiment of the present invention. The screen comprises window 600 including a display area for presenting fields for customizing preferences.

Link text may provide indicators as to whether the link refers to a next page or a previous page. For example, the link text may be “next page”. In field 602, the user may provide a list of phrases, words, or truncated words for which to search in the link text of a document. A similar indication may be found in the uniform resource locator (URL) of a link. Field 604 allows the user to provide a list of phrases, words, or truncated words for which to search in the URLs of links in the document.

Links may be represented by graphics within a document. The graphic filenames may provide clues as to whether a link refers to a next page or previous page in a series of pages. For example, a graphic may have a filename “rightarrow.gif”. A right arrow graphic may typically be used to refer to a next page in a series of pages, while a left arrow may refer to a previous page. In field 606, the user may provide a list of phrases, words, or truncated words for which to search in the graphic filenames of links within the document. Graphics also may have associated “alt text” which is displayed if the graphic cannot be retrieved. For example, the right arrow graphic may have alt text set to “right arrow.” Field 608 allows the user to provide a list of phrases, words, or truncated words for which to search in the alt text of graphical links in the document.

URLs may also provide other clues as to whether a link refers to a next page or a previous page within a series of pages. For example, the URL of a current page may be “http://domain/page01.html” and the URL of a link may be “http://domain/page02.html”. Checkbox 610 allows the user to instruct the browser to search for ascending numbers in URLs in links and checkbox 612 allows the user to instruct the browser to search for descending numbers in URLs in links. Alternatively, the browser may also search for an alphabetic sequence. For example, the URL of a current page may be “http://domain/pageA.hmtl” and the URL of a link may be “http://domain/pageB.html.” In fields 614 and 616, the user may enter keyboard shortcuts for the next and previous links. Checkbox 618 allows the user to instruct the browser to add next and previous page links to the right-click menu and checkbox 620 allows the user to instruct the browser to add next and previous page links to the toolbar.

The preferences shown in FIG. 6 may result in more than one link that may be a next page link or a previous page link. The present invention may set priorities to the fields to resolve the discovery of multiple links. For example, the invention may give more weight to the link text than the graphic filename, because the same graphic may be used for more than one link.

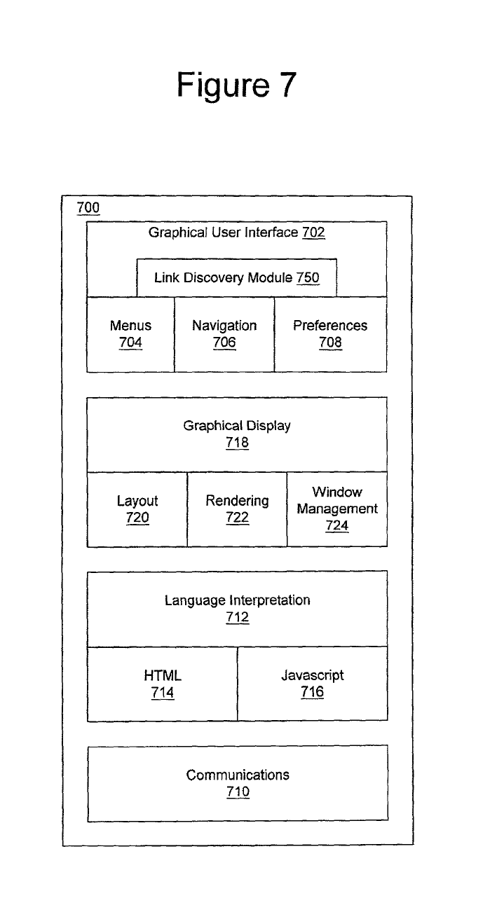

Turning next to FIG. 7, a block diagram of a browser program is depicted in accordance with a preferred embodiment of the present invention. A browser is an application used to navigate or view information or data in a distributed database, such as the Internet or the World Wide Web.

In this example, browser 700 includes a user interface 702, which is a graphical user interface (GUI) that allows the user to interface or communicate with browser 700. User interface 702 includes link discovery module 750, which discovers links to a next page and a previous page if the document is part of a series of pages. This interface provides for selection of various functions through menus 704 and allows for navigation through navigation 706. For example, menus 704 may allow a user to perform various functions, such as saving a file, opening a new window, displaying a history, and entering a URL. Menus 704 may also add next page and previous page links to the right-click menu and other navigational menus. Navigation 706 allows for a user to navigate various pages and to select web sites for viewing. For example, navigation 706 may allow a user to see a previous page or a subsequent page relative to the present page. Preferences, such as those illustrated in FIG. 6, may be set through preferences 708.

Communications 710 is the mechanism with which browser 700 receives documents and other resources from a network such as the Internet. Further, communications 710 is used to send or upload documents and resources onto a network. In the depicted example, communication 710 uses HTTP. Other protocols may be used depending on the implementation. Documents that are received by browser 700 are processed by language interpretation 712, which includes an HTML unit 714 and a JavaScript unit 716. Language interpretation 712 will process a document for presentation on graphical display 718. In particular, HTML statements are processed by HTML unit 714 for presentation while JavaScript statements are processed by JavaScript unit 716.

Graphical display 718 includes layout unit 720, rendering unit 722, and window management 724. These units are involved in presenting web pages to a user based on results from language interpretation 712.

Browser 700 is presented as an example of a browser program in which the present invention may be embodied. Browser 700 is not meant to imply architectural limitations to the present invention. Presently available browsers may include additional functions not shown or may omit functions shown in browser 700. A browser may be any application that is used to search for and display content on a distributed data processing system. Browser 700 make be implemented using known browser applications, such Netscape Navigator or Microsoft Internet Explorer. Netscape Navigator is available from Netscape Communications Corporation while Microsoft Internet Explorer is available from Microsoft Corporation.

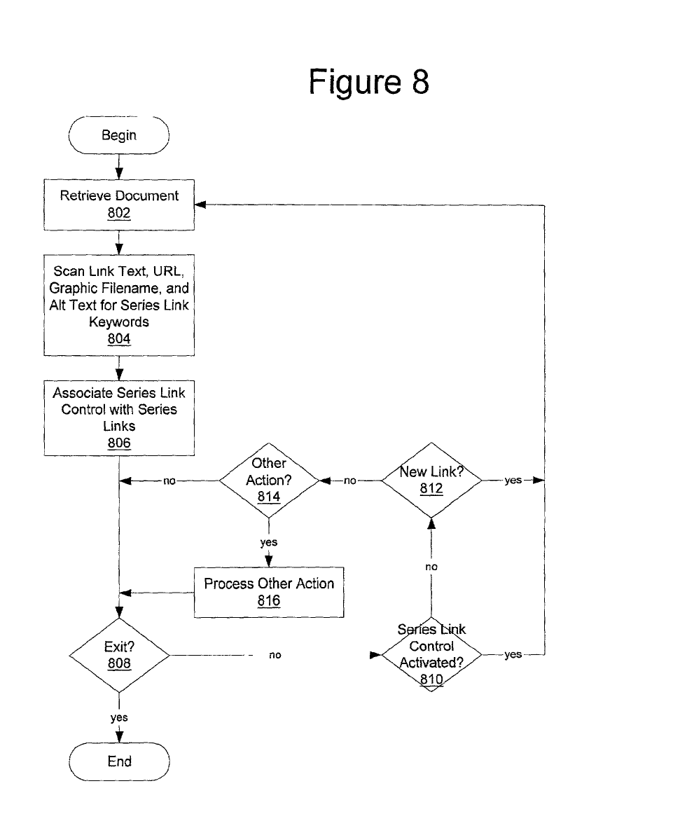

With reference to FIG. 8, a flowchart is shown illustrating the operation of a web browser in accordance with a preferred embodiment of the present invention. The process begins, retrieves a document (step 802), and scans the link text, URLs, graphic filenames, and alt text for “next” and “previous” page links (step 804). Next, the process associates a series link control with identified series links (step 806). A determination is then made as to whether an exit condition exists (step 808). An exit condition may exist when a user closes the browser window or exits through a menu command. If an exit condition exists, the process ends.

If an exit condition does not exist in step 808, a determination is made as to whether a series link control is activated (step 810). If a series link control is activated, the process returns to step 802 to retrieve the document. If a series link control is not activated, a determination is made as to whether a new link is selected (step 812), such as back, forward, or selection of a link in the document. If a new link is selected, the process returns to step 802 to retrieve the document.

If a new link is not selected in step 812, a determination is made as to whether any other action is selected (step 814). If an action is selected, the process performs the other action (step 816) and returns to step 808 to determine whether an exit condition exists. If an action is not selected in step 814, the process returns to step 808 to determine whether an exit condition exists.

Thus, the present invention solves the disadvantages of the prior art by providing a mechanism for associating a locational affinity between a series link and a cursor or tabbed focus field or other control to allow consistent paging through a series of pages without having to physically scroll the page and relocate the cursor over the link. A web browser scans for key phrases or words in links, such as “next,” “previous,” “more,” and “back.” The browser may scan the link text, uniform resource locators, graphic filenames, and alt text associated with graphics. However, the present invention is not limited to these examples. Future markup languages may provide other tags and the like to examine.

When a series link is identified, such as a “next” or “previous” page link, the browser may automatically scroll the page and reposition the mouse cursor over the link. The browser may also provide a right-click menu that provides menu items associated with next page and previous page links. Furthermore, the browser may provide buttons in a toolbar for navigation between next page and previous page links. Preferences may be defined by the user for customizing the key words and interface options in order to identify series links. Thus, the present invention enhances accessibility for users with difficulty with small motor movements and in moving a mouse.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for navigation between pages within a series of pages, comprising:
receiving a document, wherein the document comprises a current page within a series of pages;
identifying a series link in the current page, wherein the series link references a next or previous page within the series of pages; and
associating a series link control with the series link.

2. The method of claim 1, wherein the step of identifying a series link comprises:
searching at least one link in the document for a keyword.

3. The method of claim 2, wherein the step of searching at least one link comprises searching at least one of link text, graphic filename, alt text, and uniform resource locator.

4. The method of claim 1, wherein the step of identifying a series link comprises:
searching a uniform resource locator of at least one link for an ascending or descending number with respect to the uniform resource locator of the document.

5. The method of claim 1, wherein the step of identifying a series link comprises:
searching a uniform resource locator of at least one link for an alphabetic sequence with respect to the uniform resource locator of the document.

6. The method of claim 1, wherein the series link control comprises at least one of a button, a menu item, and a keyboard shortcut.

7. The method of claim 1, wherein the series link control comprises a mouse pointer.

8. The method of claim 7, wherein the step of associating the series link control with the series link comprises automatically placing the mouse pointer over the series link.

9. An apparatus for navigation between pages within a series of pages, comprising:
receipt means for receiving a document, wherein the document comprises a current page within a series of pages;
identification means for identifying a series link in the current page, wherein the series link references a next or previous page within the series of pages; and
association means for associating a series link control with the series link.

10. The apparatus of claim 9, wherein the identification means comprises:
search means for searching at least one link in the document for a keyword.

11. The apparatus of claim 10, wherein the search means comprises means for searching at least one of link text, graphic filename, alt text, and uniform resource locator.

12. The apparatus of claim 9, wherein the identification means comprises:
means for searching a uniform resource locator of at least one link for an ascending or descending number with respect to the uniform resource locator of the document.

13. The apparatus of claim 9, wherein the identification means comprises:
means for searching a uniform resource locator of at least one link for an alphabetic sequence with respect to the uniform resource locator of the document.

14. The apparatus of claim 9, wherein the series link control comprises at least one of a button, a menu item, and a keyboard shortcut.

15. The apparatus of claim 9, wherein the series link control comprises a mouse pointer.

16. The apparatus of claim 15, wherein the association means comprises means for automatically placing the mouse pointer over the series link.

17. An apparatus for navigation between pages within a series of pages, comprising:
a communications module, wherein the communications module receives a document, wherein the document comprises a current page within a series of pages; and
a link discovery module, wherein the link discovery module identifies a series link in the current page that references a next or previous page within the series of pages, and associates a series link control with the series link.

18. The apparatus of claim 17, wherein the link discovery module searches at least one link in the document for a keyword.

19. The apparatus of claim 17, wherein the link discovery module searches a uniform resource locator of at least one link for an ascending or descending number with respect to the uniform resource locator of the document.

20. The apparatus of claim 17, wherein the link discovery module searches a uniform resource locator of at least one link for an alphabetic sequence with respect to the uniform resource locator of the document.

21. The apparatus of claim 17, wherein the series link control comprises at least one of a button, a menu item, and a keyboard shortcut.

22. The apparatus of claim 17, wherein the series link control comprises a mouse pointer.

23. The apparatus of claim 22, wherein the link discovery module automatically places the mouse pointer over the series link.

24. A computer program product, in a computer readable medium, for navigation between pages within a series of pages, comprising:
instructions for receiving a document, wherein the document comprises a current page within a series of pages;
instructions for identifying a series link in the current page, wherein the series link references a next or previous page within the series of pages; and
instructions for associating a series link control with the series link.
